(19) United States
(12) Patent Application Publication
(10) Pub. No.: US 2022/0106665 A1
(43) Pub. Date: Apr. 7, 2022

(54) RECOVERY OF GOLD AND SILVER VALUES FROM FEEDSTOCKS USING ULTRASOUND-ASSISTED EXTRACTION

(71) Applicant: Central America Nickel Inc., Montréal (CA)

(72) Inventors: Pierre Gauthier, Montréal (CA); Enrico Di Cesare, Pierrefonds (CA)

(73) Assignee: Central America Nickel Inc., Montréal (CA)

(21) Appl. No.: 17/311,541

(22) PCT Filed: Dec. 13, 2019
(86) PCT No.: PCT/CA2019/051807

§ 371 Date: Jun. 7, 2021

Related U.S. Application Data
(60) Provisional application No. 62/779,754, filed on Dec. 14, 2018.

(51) Int. Cl. C22B 11/00; C22B 3/08; C22B 3/42

(52) U.S. Cl. CPC C22B 11/04; C22B 3/42; C22B 3/08

(57) ABSTRACT

The present disclosure broadly relates to a process for recovering gold and/or silver values from various feedstocks. More specifically, but not exclusively, the present disclosure relates to a process for the selective recovery of gold and/or silver values from a feedstock, the process comprising: leaching the feedstock in a sulfuric acid solution comprising thiourea while simultaneously sonicating the sulfuric acid solution thereby producing a pregnant solution; and selectively removing gold and/or silver compounds from the pregnant solution using a solvent extraction process or an ion exchange extraction process.

### CROSS REFERENCE TO RELATED APPLICATIONS

This application claims the benefit of U.S. Provisional Application 62/779,754, filed Dec. 14, 2018. The contents of the referenced application are incorporated into the present application by reference.

### FIELD

The present disclosure broadly relates to a process for selectively recovering metal values from various feedstocks. More specifically, but not exclusively, the present disclosure relates to a process for selectively recovering gold, and/or silver values from various feedstocks. More specifically, but not exclusively, the present disclosure relates to a process for recovering gold and/or silver from various feedstocks using an ultrasound assisted extraction process.

### BACKGROUND

Gold and silver are obtained from a variety of feed materials (e.g. ores), in some of which the gold predominates, in others silver is the primary value, while in still a third class these two metals may be mixed with base metals such as lead, copper, zinc, and iron. Few silver ores are absolutely free from gold, and vice versa, so that a separate consideration of the two is more or less a difficult task. In many gold-containing ores, the gold can be intimately associated with sulphidic minerals such as pyrite, pyrrhotite, arsenopyrite, marcasite, chalcopyrite, chalcocite, bornite, enargite, etc. The gold present in association with these sulphidic minerals often cannot be economically recovered using cyanide without the ore being given a pretreatment such as roasting, pressure oxidation or bacterial oxidation.

Many extraction processes call upon hydrometallurgy, that is the use of an acidic leaching medium. These hydrometallurgical processes are typically very capital expensive in view of the high costs incurred by material requirements as well as the high temperatures and/or pressures required for efficient leaching. Moreover, with many existing extraction procedures, the presence of one metal may prevent a smooth extraction of another one, as is observed in the case of gold extraction with cyanide, while in the presence of silver or copper.

In view of ever increasing environmental concerns, the need for improved technologies providing for a more efficient and affordable extraction of the gold and silver values has intensified. Indeed, in accordance with today's environmental concerns, any new extraction technology should not adversely impact the environment or leave as little an imprint as possible.

The present disclosure refers to a number of documents, the contents of which are specifically incorporated herein by reference in their entirety.

### SUMMARY

A solution to the shortcomings of the prior art processes associated with the presence of other values has been discovered. Broadly, the solution resides in the discovery that by concomitant leaching and sonication, a pregnant solution can ultimately be obtained that is enriched substantially in gold and silver values.

In an aspect, the present disclosure broadly relates to a process for selectively recovering metal values from various feedstocks. More specifically, but not exclusively, the present disclosure relates to a process for selectively recovering gold, and/or silver values from various feedstocks. More specifically, but not exclusively, the present disclosure relates to a process for recovering gold and/or silver from various feedstocks using an ultrasound assisted extraction process.

In an aspect, the present disclosure relates to a process for the selective recovery of gold and/or silver values from a feedstock, the process comprising: leaching the feedstock in a sulfuric acid solution while simultaneously sonicating the sulfuric acid solution, thereby producing a pregnant solution; and selectively removing gold and silver compounds from the pregnant solution.

In an aspect, the present disclosure relates to a process for the selective recovery of gold and/or silver values from a feedstock, the process comprising: leaching the feedstock in a sulfuric acid solution while simultaneously sonicating the sulfuric acid solution, thereby producing a pregnant solution; and selectively removing gold and/or silver compounds from the pregnant solution using either a suitable ion exchange resin or a suitable solvent extraction process. In an embodiment of the present disclosure, the solvent extraction process comprises the use of PIONERA Biopolymer for removing the gold compounds from the pregnant solution. In an embodiment of the present disclosure, the feedstocks comprise materials containing gold and/or silver in various oxidation states.

In an embodiment of the present disclosure, the sulfuric acid leaching/sonication is performed using an aqueous solution of sulfuric acid having a mass percentage from about 5% v/v H₂SO₄ to about 100% v/v H₂SO₄. In a further embodiment of the present disclosure, the sulfuric acid leaching/sonication is performed using an aqueous solution of sulfuric acid having a mass percentage from about 10% v/v H₂SO₄ to about 99% v/v H₂SO₄. In a further embodiment of the present disclosure, the sulfuric acid leaching/sonication is performed using an aqueous solution of sulfuric acid having a mass percentage from about 15% v/v H₂SO₄ to about 99% v/v H₂SO₄. In a further embodiment of the present disclosure, the sulfuric acid leaching/sonication is performed using an aqueous solution of sulfuric acid having a mass percentage from about 20% v/v H₂SO₄ to about 99% v/v H₂SO₄. In a further embodiment of the present disclosure, the sulfuric acid leaching/sonication is performed using an aqueous solution of sulfuric acid having a mass percentage from about 25% v/v H₂SO₄ to about 99% v/v H₂SO₄. In a further embodiment of the present disclosure, the sulfuric acid leaching/sonication is performed using an aqueous solution of sulfuric acid having a mass percentage from about 30% v/v H₂SO₄ to about 99% v/v H₂SO₄. In a further embodiment of the present disclosure, the sulfuric acid leaching/sonication is performed using an aqueous solution of sulfuric acid having a mass percentage from about 35% v/v H₂SO₄ to about 99% v/v H₂SO₄. In a further embodiment of the present disclosure, the sulfuric acid leaching/sonication is performed using an aqueous solution of sulfuric acid having a mass percentage from about 40% v/v H₂SO₄ to about 99% v/v H₂SO₄. In a further embodiment of the present disclosure, the sulfuric acid leaching/sonication is performed using an aqueous solution of sulfuric acid having a mass percentage from about 45% v/v H₂SO₄ to about 99% v/v H₂SO₄. In a further embodiment of the present disclosure, the sulfuric acid leaching/sonication is performed using an aqueous solution of sulfuric acid having a mass percentage from about 50% v/v H₂SO₄ to about 99% v/v H₂SO₄.

In an embodiment of the present disclosure, the sulfuric acid leaching/sonication is performed at a frequency ranging from about 10 to 70 kHz. In a further embodiment of the present disclosure, the sulfuric acid leaching/sonication is performed at a frequency ranging from about 10 to about 60 kHz. In a further embodiment of the present disclosure, the sulfuric acid leaching/sonication is performed at a frequency ranging from about 10 to about 50 kHz. In a further embodiment of the present disclosure, the sulfuric acid leaching/sonication is performed at a frequency ranging from about 10 to about 40 kHz. In a further embodiment of the present disclosure, the sulfuric acid leaching/sonication is performed at a frequency ranging from about 20 to about 30 kHz.

In an embodiment of the present disclosure, the sulfuric acid leaching/sonication is performed over a period ranging from about five (5) minutes up to about one hundred and twenty (120) minutes. In a further embodiment of the present disclosure, the sulfuric acid leaching/sonication is performed over a period ranging from about five (5) minutes up to about ninety (90) minutes. In a further embodiment of the present disclosure, the sulfuric acid leaching/sonication is performed over a period ranging from about five (5) minutes up to about sixty (60) minutes. In a further embodiment of the present disclosure, the sulfuric acid leaching/sonication is performed over a period ranging from about ten (10) minutes up to about fifty (50) minutes. In a further embodiment of the present disclosure, the sulfuric acid leaching/sonication is performed over a period ranging from about fifteen (15) minutes up to about forty (40) minutes. In a further embodiment of the present disclosure, the sulfuric acid leaching/sonication is performed over a period ranging from about twenty (20) minutes up to about thirty five (35) minutes.

In an embodiment of the present disclosure, the feedstock material is ground to a particle size of less than about 0.500 millimeters. In a further embodiment of the present disclosure, the feedstock material is ground to a particle size of less than about 0.125 millimeters. In yet a further embodiment of the present disclosure, the feedstock material is ground to a particle size of less than about 0.050 millimeters.

In an embodiment of the present disclosure, the sulfuric acid leaching/sonication is performed at atmospheric pressure at about room temperature.

In an embodiment of the present disclosure, the sulfuric acid leaching/sonication is performed with a solution of sulfuric acid (S) and a mass of ore material (M) having a mass ratio (S-to-M) not exceeding twenty to one (20:1 or 20 kg/kg).

Also disclosed in the context of the present disclosure are embodiments 1 to 32. Embodiment 1 is a process for the selective recovery of gold and/or silver values from an ore material, the process comprising: leaching the ore material in a sulfuric acid solution comprising thiourea while simultaneously sonicating the sulfuric acid solution thereby producing a pregnant solution; and selectively removing gold and/or silver compounds from the pregnant solution. Embodiment 2 is the process of embodiment 1, further comprising subjecting the pregnant solution to a solvent extraction process or an ion exchange extraction process. Embodiment 3 is the process of embodiment 1 or 2, wherein the ore material comprises gold and/or silver in various oxidation states. Embodiment 4 is the process of any one of embodiments 1 to 3, wherein the sulfuric acid leaching comprises using an aqueous solution of sulfuric acid having a mass percentage from about 5% v/v H₂SO₄ to about 100% v/v H₂SO₄. Embodiment 5 is the process of any one of embodiments 1 to 4, wherein the sulfuric acid leaching comprises using an aqueous solution of sulfuric acid having a mass percentage from about 10% v/v H₂SO₄ to about 99% v/v H₂SO₄. Embodiment 6 is the process of any one of embodiments 1 to 5, wherein the sulfuric acid leaching comprises using an aqueous solution of sulfuric acid having a mass percentage from about 15% v/v H₂SO₄ to about 99% v/v H₂SO₄. Embodiment 7 is the process of any one of embodiments 1 to 6, wherein the sulfuric acid leaching comprises using an aqueous solution of sulfuric acid having a mass percentage from about 20% v/v H₂SO₄ to about 99% v/v H₂SO₄. Embodiment 8 is the process of any one of embodiments 1 to 7, wherein the sulfuric acid leaching comprises using an aqueous solution of sulfuric acid having a mass percentage from about 25% v/v H₂SO₄ to about 99% v/v H₂SO₄. Embodiment 9 is the process of any one of embodiments 1 to 8, wherein the sulfuric acid leaching comprises using an aqueous solution of sulfuric acid having a mass percentage from about 30% v/v H₂SO₄ to about 99% v/v H₂SO₄. Embodiment 10 is the process of any one of embodiments 1 to 9, wherein the sulfuric acid leaching comprises using an aqueous solution of sulfuric acid having a mass percentage from about 35% v/v H₂SO₄ to about 99% v/v H₂SO₄. Embodiment 11 is the process of any one of embodiments 1 to 10, wherein the sulfuric acid leaching comprises using an aqueous solution of sulfuric acid having a mass percentage from about 40% v/v H₂SO₄ to about 99% v/v H₂SO₄. Embodiment 12 is the process of any one of embodiments 1 to 11, wherein the sulfuric acid leaching comprises using an aqueous solution of sulfuric acid having a mass percentage from about 45% v/v H₂SO₄ to about 99% v/v H₂SO₄. Embodiment 13 is the process of any one of embodiments 1 to 12, wherein the sulfuric acid leaching comprises using an aqueous solution of sulfuric acid having a mass percentage from about 50% v/v H₂SO₄ to about 99% v/v H₂SO₄. Embodiment 14 is the process of any one of embodiments 1 to 13, wherein the sonication is performed at a frequency ranging from about 10 to about 70 kHz. Embodiment 15 is the process of any one of embodiments 1 to 14, wherein the sonication is performed at a frequency ranging from about 10 to about 60 kHz. Embodiment 16 is the process of any one of embodiments 1 to 15, wherein the sonication is performed at a frequency ranging from about 10 to about 50 kHz. Embodiment 17 is the process of any one of embodiments 1 to 16, wherein the sonication is performed at a frequency ranging from about 10 to about 40 kHz. Embodiment 18 is the process of any one of embodiments 1 to 17, wherein the sonication is performed at a frequency ranging from about 20 to about 30 kHz. Embodiment 19 is the process of any one of embodiments 1 to 18, wherein the leaching/sonication is performed over a period ranging from about five (5) minutes up to about one hundred and twenty (120) minutes. Embodiment 20 is the process of any one of embodiments 1 to 19, wherein the leaching/sonication is performed over a period ranging from about five (5) minutes up to about ninety (90) minutes. Embodiment 21 is the process of any one of embodiments 1 to 20, wherein the leaching/sonication is performed over a period ranging from about five (5) minutes up to about sixty (60) minutes. Embodiment 22 is the process of any one of embodiments 1 to 21, wherein the leaching/sonication is performed over a period ranging from about ten (10) minutes up to about fifty (50) minutes. Embodiment 23 is the process of any one of embodiments 1 to 22, wherein the leaching/sonication is performed over a period ranging from about fifteen (15) minutes up to about forty (40) minutes. Embodiment 24 is the process of any one of embodiments 1 to 23, wherein the leaching/sonication is performed over a period ranging from about twenty (20) minutes up to about thirty five (35) minutes. Embodiment 25 is the process of any one of embodiments 1 to 24, wherein the ore material is ground to a particle size of less than about 0.500 millimeters. Embodiment 26 is the process of any one of embodiments 1 to 25, wherein the ore material is ground to a particle size of less than about 0.125 millimeters. Embodiment 27 is the process of any one of embodiments 1 to 26, wherein the ore material is ground to a particle size of less than about 0.050 millimeters. Embodiment 28 is the process of any one of embodiments 1 to 27, wherein the leaching/sonication is performed at atmospheric pressure at about room temperature. Embodiment 29 is the process of any one of embodiments 1 to 28, wherein the leaching/sonication is performed with a solution of sulfuric acid (S) and a mass of ore material (M) having a mass ratio (S-to-M) not exceeding twenty to one (20:1 or 20 kg/kg). Embodiment 30 is the process of embodiment 1, wherein the pregnant solution is at a pH below 2.0.

Embodiment 31 is a process for the selective recovery of gold values from an ore material, the process comprising leaching the ore material in a sulfuric acid solution while simultaneously sonicating the sulfuric acid solution for a time sufficient to produce a pregnant solution substantially enriched in gold.

Embodiment 32 is a process for the selective recovery of silver values from an ore material, the process comprising leaching the ore material in a sulfuric acid solution while simultaneously sonicating the sulfuric acid solution for a time sufficient to produce a pregnant solution substantially enriched in silver

The foregoing and other objects, advantages and features of the present disclosure will become more apparent upon reading of the following non-restrictive description of illustrative embodiments thereof, given by way of example only with reference to the accompanying drawings/figures.

### BRIEF DESCRIPTION OF THE DRAWINGS/FIGURES

In the appended drawings/figures:

FIG. 1 is an illustration of a magnetic drum separator in accordance with an embodiment of the present disclosure.

FIG. 2 is an illustration of a Knelson separator in accordance with an embodiment of the present disclosure.

FIG. 3 is a flowchart illustrating the ultrasound-assisted extraction process of various valuables in accordance with an embodiment of the present disclosure.

### DETAILED DESCRIPTION

Glossary

In order to provide a clear and consistent understanding of the terms used in the present specification, a number of definitions are provided below. Moreover, unless defined otherwise, all technical and scientific terms as used herein have the same meaning as commonly understood to one of ordinary skill in the art to which this disclosure pertains.

Unless otherwise indicated, the definitions and embodiments described in this and other sections are intended to be applicable to all embodiments and aspects of the application herein described for which they are suitable as would be understood by a person skilled in the art.

The word “a” or “an” when used in conjunction with the term “comprising” in the claims and/or the disclosure may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

As used in this disclosure and claim(s), the word “consisting” and its derivatives, are intended to be close ended terms that specify the presence of stated features, elements, components, groups, integers, and/or steps, and also exclude the presence of other unstated features, elements, components, groups, integers and/or steps.

The term “consisting essentially of”, as used herein, is intended to specify the presence of the stated features, elements, components, groups, integers, and/or steps as well as those that do not materially affect the basic and novel characteristic(s) of these features, elements, components, groups, integers, and/or steps.

The terms “about”, “substantially” and “approximately” as used herein mean a reasonable amount of deviation of the modified term such that the end result is not significantly changed. These terms of degree should be construed as including a deviation of at least ±1% of the modified term if this deviation would not negate the meaning of the word it modifies.

As used herein, the term “gold feedstocks” refers to a range of materials containing gold in various oxidation states and gold metal.

As used herein, the term “silver feedstocks” refers to a range of materials containing silver in various oxidation states and silver metal.

As used herein, the term “sulfuric acid digestion” broadly refers to the digestion of a solid with sulfuric acid having a concentration ranging from about 5% v/v to about 100% v/v.

The term “substantially” as used herein with reference to the process steps disclosed herein means that the process steps proceed to an extent that conversion or recovery of the material is maximized. For example, with reference to recovery of a given metallic value (e.g. gold and/or silver), recovery means that at least 60% of the value is recovered.

In an embodiment of the present disclosure, the ultrasound-assisted extraction process comprises the concentration by gravity and/or magnetic extraction and leaching/sonication of gold and/or silver valuables from a feedstock. In an embodiment of the present disclosure, the leaching is performed using sulfuric acid under sonication. In an embodiment, the mass percentage of sulfuric acid used during this step ranges from about 5% v/v H₂SO₄ to about 100% v/v H₂SO₄. In a further embodiment, the mass percentage of sulfuric acid ranges from about 10% v/v H₂SO₄ to about 99% v/v H₂SO₄. In a further embodiment, the mass percentage of sulfuric acid ranges from about 15% v/v H₂SO₄ to about 99% v/v H₂SO₄. In a further embodiment, the mass percentage of sulfuric acid ranges from about 20% v/v H₂SO₄ to about 99% v/v H₂SO₄. In a further embodiment, the mass percentage of sulfuric acid ranges from about 25% v/v H₂SO₄ to about 99% v/v H₂SO₄. In a further embodiment, the mass percentage of sulfuric acid ranges from about 30% v/v H₂SO₄ to about 99% v/v H₂SO₄. In a further embodiment, the mass percentage of sulfuric acid ranges from about 35% v/v H₂SO₄ to about 99% v/v H₂SO₄. In a further embodiment, the mass percentage of sulfuric acid ranges from about 40% v/v H₂SO₄ to about 99% v/v H₂SO₄. In a further embodiment, the mass percentage of sulfuric acid ranges from about 45% v/v H₂SO₄ to about 99% v/v H₂SO₄. In a further embodiment, the mass percentage of sulfuric acid ranges from about 50% v/v H₂SO₄ to about 99% v/v H₂SO₄. In a further embodiment, the mass percentage of sulfuric acid ranges from about 55% v/v H₂SO₄ to about 99% v/v H₂SO₄. In a further embodiment, the mass percentage of sulfuric acid ranges from about 60% v/v H₂SO₄ to about 99% v/v H₂SO₄. In further embodiments, the mass percentage of sulfuric acid ranges from about 10% v/v H₂SO₄ to about 95% v/v H₂SO₄; from about 25% v/v H₂SO₄ to about 50% v/v H₂SO₄; or from about 10% v/v H₂SO₄ to about 40% v/v H₂SO₄.

In an embodiment of the present disclosure, the ultrasound-assisted extraction process comprises the concentration by gravity and/or magnetic extraction and leaching/sonication of gold and/or silver valuables from a feedstock. In an embodiment of the present disclosure, the leaching is performed using sulfuric acid under sonication. In an embodiment, the sonication is performed at a frequency ranging from about 10 to 70 kHz. In a further embodiment of the present disclosure, the sulfuric acid leaching/sonication is performed at a frequency ranging from about 10 to about 60 kHz. In a further embodiment of the present disclosure, the sulfuric acid leaching/sonication is performed at a frequency ranging from about 10 to about 50 kHz. In a further embodiment of the present disclosure, the sulfuric acid leaching/sonication is performed at a frequency ranging from about 10 to about 40 kHz. In a further embodiment of the present disclosure, the sulfuric acid leaching/sonication is performed at a frequency ranging from about 20 to about 30 kHz.

In an embodiment of the present disclosure, the ultrasound-assisted extraction process comprises the concentration by gravity and/or magnetic extraction and leaching/sonication of gold and/or silver valuables from a feedstock. In an embodiment of the present disclosure, the leaching is performed using sulfuric acid under sonication. In an embodiment of the present disclosure, the leaching/sonication is performed over a period ranging from about five (5) minutes up to about one hundred and twenty (120) minutes. In a further embodiment of the present disclosure, the sulfuric acid leaching/sonication is performed over a period ranging from about five (5) minutes up to about ninety (90) minutes. In a further embodiment of the present disclosure, the sulfuric acid leaching/sonication is performed over a period ranging from about five (5) minutes up to about sixty (60) minutes. In a further embodiment of the present disclosure, the sulfuric acid leaching/sonication is performed over a period ranging from about ten (10) minutes up to about fifty (50) minutes. In a further embodiment of the present disclosure, the sulfuric acid leaching/sonication is performed over a period ranging from about fifteen (15) minutes up to about forty (40) minutes. In a further embodiment of the present disclosure, the sulfuric acid leaching/sonication is performed over a period ranging from about twenty (20) minutes up to about thirty five (35) minutes.

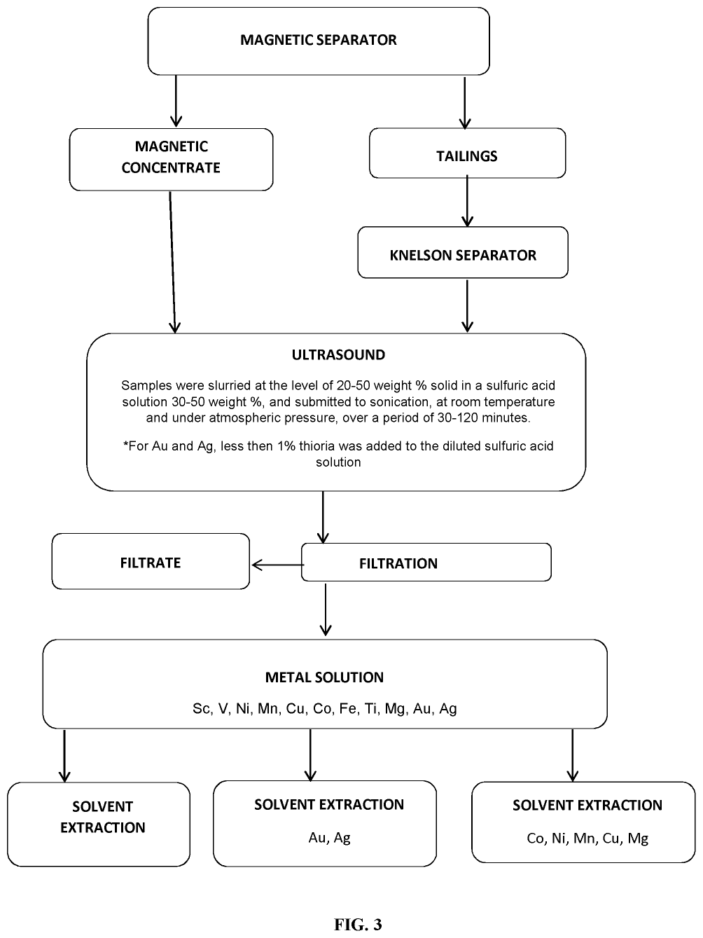

In an embodiment of the present disclosure, a Knelson separator such as illustrated in FIG. 2 is used to capture values comprising heavy metals. The Knelson separator is a compact centrifugal separator comprising a fluidized bed. In an embodiment of the present disclosure, a centrifugal force of up to 90 g is applied on the particulate feedstock fed into the multi-level rotating bowl of the separator. A person skilled in the art would understand that various centrifugal forces can be applied and it is within their skill to do so.

The fluidized bed is generated by means of numerous perforations around the separating bowl of the Knelson separator. As the feed material (e.g. a slurry) is fed into the multi-level rotating bowl, the less dense material is pushed out while the heavier materials make their way toward the outer wall of the rotating bowl. Once the sample has been completely processed, the water source (e.g. pressurized water) is closed and the rotating bowl is stopped and emptied. In an embodiment of the present disclosure, the contents of the bowl are subsequently fed into a gravity separating unit called a “superspanner”. In a particular embodiment of the present disclosure, the superspanner is used to determine the presence of free gold.

### EXPERIMENTAL

A number of non-limiting examples are provided hereinbelow, illustrating the various steps of the ultrasound-assisted extraction process in accordance with various embodiments of the process of the present disclosure (Table 1).

Magnetic Separation

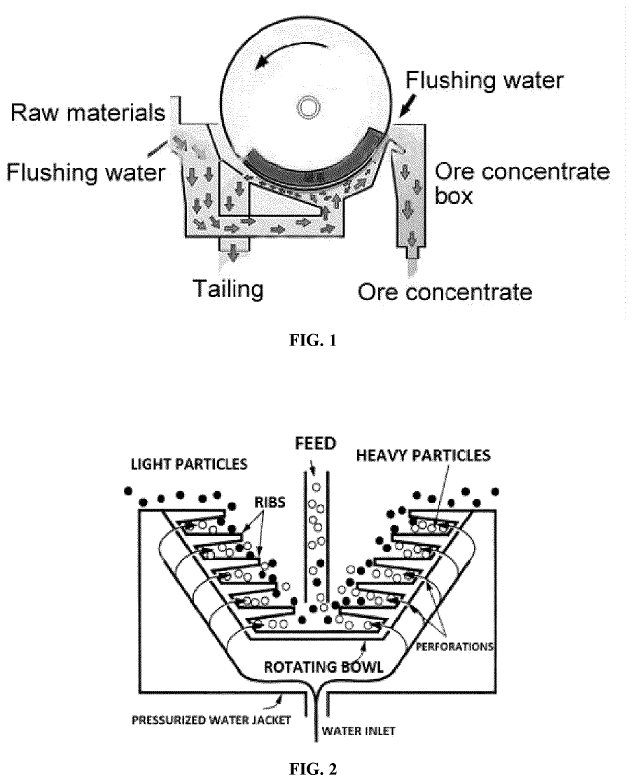

An Aguamas or Campanillas feed material was upgraded by feeding the material as a slurry through a low intensity magnetic drum separator. A typical magnetic drum separator in accordance with an embodiment of the present disclosure is illustrated in FIG. 1. In an embodiment of the present disclosure, the low intensity magnetic drum separator (Eriez LWD Separator) comprises an electrically induced magnet generating a field of about 1000 gauss. A person skilled in the art would understand that various magnetic fields can be applied and it is within their skill to do so. The feed material was initially slurried in a 30 L tank equipped with a speed adjustable motor and impeller. The resulting slurry was then slowly pumped into the magnetic drum separator. Concentrates and tailings were subsequently discharged from the magnetic drum separator into separate drums, filtered, dried and weighed.

Sulfuric Acid Digestion (Leaching)—General Procedure

Leaching experiments were typically performed using 30 g of feed material and a 50%-80% v/v H₂SO₄ solution. The ratio of sulfuric acid to feed material ranges from 10:1 to 1:1 by weight. In an embodiment, the sulfuric acid to feed material ratio was 5:1 by weight. A person skilled in the art would understand that various sulfuric acid to feed material ratios can be applied and it is within their skill to do so. The leaching experiments were typically performed at room temperature and under atmospheric pressure.

Sonication—General Procedure

The sonication of the leaching solution was performed using a Q700 sonicator operating at 20 KHz (700 W) and equipped with a titanium solid tip sonotrode (19 mm wide, 70 mm long) set at an amplitude of 60%. The power consumption was initially around 30 W and the total energy consumption varies between 135 to 145 KJoules. In an embodiment of the present disclosure, the leaching step was carried out over a period of one hour. A person skilled in the art would understand that various leaching/sonication times can be applied and it is within their skill to do so. By the end of the sonication/leaching step, the temperature of the sample ranges between about 40° C. to about 100° C. The material was subsequently cooled to room temperature, followed by washing with water and filtration under vacuum. The elemental composition of the resulting material was determined by X-ray fluorescence analysis (XRF) using an S8 Tiger Series 2 WDXRF spectrometer from Brucker. The recovery efficiency of the valuables was determined by measuring the elemental composition of the feed material using the aforementioned S8 Tiger Series 2 WDXRF spectrometer from Brucker.

Ultrasound Assisted Extraction of Au and Ag

Au and/or Ag were selectively extracted from various solid feed materials, non-limiting examples of which include soil, sediments and silica ores. More specifically, Au and/or Ag were selectively extracted from feed materials obtained from the Aguamas and Campanillas mines in Sinaloa, Mexico.

Thiourea (<1%) was added to an aqueous sulfuric acid solution in order to effectively and selectively extract the Au and/or Ag values from the feed material. Following sonication/leaching, performed over a period of 1 hour, over 90% of the Au and over 80% of the Ag were recovered (Table 1). The extraction was performed at room temperature and under atmospheric pressure.

Aguamas Mine

An ore from the Aguamas mine (20 wt %) comprising 0.01% Au and 0.08% Ag was leached with a 80% v/v H₂SO₄ solution comprising thiourea (<1%). The resulting slurry was subsequently sonicated with stirring while at room temperature and under atmospheric pressure over a period of 60 minutes. By the end of the sonication/leaching step, the temperature of the sample had risen. The material was subsequently cooled to room temperature, followed by washing with water and filtration under vacuum. Elemental analysis confirmed that 98% of the Au and 88.76% of the Ag were extracted. The subsequent recovery of the Au and Ag values was achieved by solvent extraction or by ion exchange extraction using a suitable resin.

Campanillas Mine

An ore from the Campanillas mine (20 wt %) comprising 0.05% Au and 0.05% Ag was leached with a 50% v/v H₂SO₄ solution comprising thiourea (<1%). The resulting slurry was subsequently sonicated with stirring while at room temperature and under atmospheric pressure over a period of 60 minutes. By the end of the sonication/leaching step, the temperature of the sample had risen. The material was subsequently cooled to room temperature, followed by washing with water and filtration under vacuum. Elemental analysis confirmed that 98% of the Au and 87.47% of the Ag were extracted. The subsequent recovery of the Au and Ag values was achieved by solvent extraction or by ion exchange extraction using a suitable resin.

TABLE 1
Au and Ag Recovery from samples from the Aguamas
and Campanillas mines in Sinaloa, Mexico

| | Au (%) | Ag (%) |
|---|---|---|
| Aguamas | 98.0 | 88.76 |
| Campanillas | 98.0 | 87.47 |

In an embodiment of the present disclosure, ores containing both silver and gold were leached with aqueous H₂SO₄ and ultrasound to successfully recover gold followed by filtering and adding a mixed acid leach (adding 1% thiourea to the sulfuric acid) to successfully recover the silver that did not leach in the first step. The two-step process illustrates that excellent gold and silver recovery can be achieved. Alternatively, by performing the leaching step using mixed acid (sulfuric acid comprising thiourea), both gold and silver are recovered in one step.

While the present disclosure has been described with reference to what are presently considered to be the preferred examples, it is to be understood that the disclosure is not limited to the disclosed examples. To the contrary, the disclosure is intended to cover various modifications and equivalent arrangements included within the spirit and scope of the appended claims.

1. A process for the selective recovery of gold and/or silver values from an ore material, the process comprising:
leaching the ore material in a sulfuric acid solution comprising thiourea while simultaneously sonicating the sulfuric acid solution thereby producing a pregnant solution; and
selectively removing gold and/or silver compounds from the pregnant solution.

2. The process of claim 1, further comprising subjecting the pregnant solution to a solvent extraction process or an ion exchange extraction process.

3. The process of claim 1 or 2, wherein the ore material comprises gold and/or silver in various oxidation states.

4. The process of any one of claims 1 to 3, wherein the sulfuric acid leaching comprises using an aqueous solution of sulfuric acid having a mass percentage from about 5% v/v H₂SO₄ to about 100% v/v H₂SO₄.

5. The process of any one of claims 1 to 4, wherein the sulfuric acid leaching comprises using an aqueous solution of sulfuric acid having a mass percentage from about 10% v/v H₂SO₄ to about 99% v/v H₂SO₄.

6. The process of any one of claims 1 to 5, wherein the sulfuric acid leaching comprises using an aqueous solution of sulfuric acid having a mass percentage from about 15% v/v H₂SO₄ to about 99% v/v H₂SO₄.

7. The process of any one of claims 1 to 6, wherein the sulfuric acid leaching comprises using an aqueous solution of sulfuric acid having a mass percentage from about 20% v/v H₂SO₄ to about 99% v/v H₂SO₄.

8. The process of any one of claims 1 to 7, wherein the sulfuric acid leaching comprises using an aqueous solution of sulfuric acid having a mass percentage from about 25% v/v H₂SO₄ to about 99% v/v H₂SO₄.

9. The process of any one of claims 1 to 8, wherein the sulfuric acid leaching comprises using an aqueous solution of sulfuric acid having a mass percentage from about 30% v/v H₂SO₄ to about 99% v/v H₂SO₄.

10. The process of any one of claims 1 to 9, wherein the sulfuric acid leaching comprises using an aqueous solution of sulfuric acid having a mass percentage from about 35% v/v H₂SO₄ to about 99% v/v H₂SO₄.

11. The process of any one of claims 1 to 10, wherein the sulfuric acid leaching comprises using an aqueous solution of sulfuric acid having a mass percentage from about 40% v/v H₂SO₄ to about 99% v/v H₂SO₄.

12. The process of any one of claims 1 to 11, wherein the sulfuric acid leaching comprises using an aqueous solution of sulfuric acid having a mass percentage from about 45% v/v H₂SO₄ to about 99% v/v H₂SO₄.

13. The process of any one of claims 1 to 12, wherein the sulfuric acid leaching comprises using an aqueous solution of sulfuric acid having a mass percentage from about 50% v/v H₂SO₄ to about 99% v/v H₂SO₄.

14. The process of any one of claims 1 to 13, wherein the sonication is performed at a frequency ranging from about 10 to about 70 kHz.

15. The process of any one of claims 1 to 14, wherein the sonication is performed at a frequency ranging from about 10 to about 60 kHz.

16. The process of any one of claims 1 to 15, wherein the sonication is performed at a frequency ranging from about 10 to about 50 kHz.

17. The process of any one of claims 1 to 16, wherein the sonication is performed at a frequency ranging from about 10 to about 40 kHz.

18. The process of any one of claims 1 to 17, wherein the sonication is performed at a frequency ranging from about 20 to about 30 kHz.

19. The process of any one of claims 1 to 18, wherein the leaching/sonication is performed over a period ranging from about five (5) minutes up to about one hundred and twenty (120) minutes.

20. The process of any one of claims 1 to 19, wherein the leaching/sonication is performed over a period ranging from about five (5) minutes up to about ninety (90) minutes.

21. The process of any one of claims 1 to 20, wherein the leaching/sonication is performed over a period ranging from about five (5) minutes up to about sixty (60) minutes.

22. The process of any one of claims 1 to 21, wherein the leaching/sonication is performed over a period ranging from about ten (10) minutes up to about fifty (50) minutes.

23. The process of any one of claims 1 to 22, wherein the leaching/sonication is performed over a period ranging from about fifteen (15) minutes up to about forty (40) minutes.

24. The process of any one of claims 1 to 23, wherein the leaching/sonication is performed over a period ranging from about twenty (20) minutes up to about thirty five (35) minutes.

25. The process of any one of claims 1 to 24, wherein the ore material is ground to a particle size of less than about 0.500 millimeters.

26. The process of any one of claims 1 to 25, wherein the ore material is ground to a particle size of less than about 0.125 millimeters.

27. The process of any one of claims 1 to 26, wherein the ore material is ground to a particle size of less than about 0.050 millimeters.

28. The process of any one of claims 1 to 27, wherein the leaching/sonication is performed at atmospheric pressure at about room temperature.

29. The process of any one of claims 1 to 28, wherein the leaching/sonication is performed with a solution of sulfuric acid (S) and a mass of ore material (M) having a mass ratio (S-to-M) not exceeding twenty to one (20:1 or 20 kg/kg).

30. The process of claim 1, wherein the pregnant solution is at a pH below 2.0.

31. A process for the selective recovery of gold values from an ore material, the process comprising leaching the ore material in a sulfuric acid solution while simultaneously sonicating the sulfuric acid solution for a time sufficient to produce a pregnant solution substantially enriched in gold.

32. A process for the selective recovery of silver values from an ore material, the process comprising leaching the ore material in a sulfuric acid solution while simultaneously sonicating the sulfuric acid solution for a time sufficient to produce a pregnant solution substantially enriched in silver.
